(19) United States
(12) Patent Application Publication
(10) Pub. No.: US 2009/0156260 A1
(43) Pub. Date: Jun. 18, 2009

(54) METHOD AND APPARATUS FOR ELECTRICAL INTERCONNECTION FOR A ROTATIONALLY OPENING ELECTRONIC DEVICE

(75) Inventors: Thomas DERENGOWSKI, Park Ridge, IL (US); Mark Oliver, Mundelein, IL (US); Thomas Petrella, Walworth, WI (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/956,544

(22) Filed: Dec. 14, 2007

(51) Int. Cl. H04M 1/02

(52) U.S. Cl. 455/566; 455/575.4

(57) ABSTRACT

A method and apparatus that electrically connects a stationary housing and a rotating housing of a device through a hinge assembly is disclosed. The method may include a spline hinge assembly having first and second access planes, and a cable that is ribbonized at the housing and bundled at the hinge assembly that has the ability to transmit torque from the fixed half of the device to the rotating half. A split construction hinge assembly allows the rotational half of the device to be a separate sub-assembly from the fixed half sub-assembly. Through an index/castled spline, the two halves can be properly aligned and assembled, and have the ability to transmit a torque.

### BACKGROUND OF THE INVENTION

1. Field of the Invention

The present invention relates generally to electronic devices and more particularly, to the routing of an electrical cable connecting a rotating housing to a stationary housing of the electronic device.

2. Introduction

There is a trend within the field of electronic devices, and especially within the field of cellular phones to split the phones in two parts that may be turned or rotated in relation to each other. Example electronic devices are Motorola's i90c, i95c1, V60, V66, and Timeport P8097 phones are configurable into their open and closed positions by rotating one part of the phone containing the audio transducer about a hinge relative to another part of the phone containing the microphone, wherein the rotation of the flip member occurs in a plane perpendicular to the plane containing the base member. Such phones or devices are typically referred to as “clamshell” or “flip” devices. Electronic devices such as Motorola's V70 phone are configurable into their open and closed positions by similarly rotating the part of the phone containing the audio transducer relative to another part of the phone containing the microphone; however, in these devices, the rotation occurs in a plane substantially parallel to the plane containing the part of the device housing the microphone. Electronic devices such as Motorola's V70 phone may be referred to as “twist”, “swivel”, or “rotational” devices. Reconfigurable devices such as the V70 are used primarily to minimize the size of the device while the device is in its standby mode or closed position, while providing a more conventional phone or device feel to the user when the device is in its in-use mode or open position.

However, due to the reduction in size of these electronic devices, it becomes more difficult to have all circuits confined exclusively to one particular area of the communication device. This leads to the need of providing signals and power between the two parts or halves while at the same time allowing safe rotation of the two parts in relation to each other. One way is to route signals and power is to provide a flex film with conductors known as a flex circuit in the interior of a hinge. However, such a film may be subject to bending causing damage to the conductors and due to the physical characteristics of the film may impede the rotation of the hinge.

For the reasons stated above, and for other reasons stated below which will become apparent to those skilled in the art upon reading and understanding the present specification, there is a need in the art for electrically connecting a stationary housing and a rotating housing of a device. There is also a need for a hinge to align and integrate the rotating housing to the stationary housing of a rotator phone.

### SUMMARY OF THE INVENTION

A method and apparatus that electrically connects a stationary housing and a rotating housing of a device through a hinge assembly is disclosed. The method may include a spline hinge assembly having first and second access planes, and a cable that is ribbonized at the housing and bundled at the hinge assembly that has the ability to transmit torque from the fixed half of the device to the rotating half. A split construction hinge assembly allows the rotational half of the device to be a separate sub-assembly from the fixed half sub-assembly. Through an index/castled spline, the two halves can be properly aligned and assembled, and have the ability to transmit a torque.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a rotator phone in accordance with a possible embodiment of the invention;

FIG. 2 illustrates an exemplary spline hinge assembly in accordance with a possible embodiment of the invention;

FIG. 3 illustrates an exemplary spline hinge assembly at the stationary half of a device in accordance with a possible embodiment of the invention;

FIG. 4 illustrates an exemplary spline hinge assembly at the rotational half of a device in accordance with a possible embodiment of the invention;

FIG. 5 illustrates an exemplary spline hinge assembly with a bridge in accordance with a possible embodiment of the invention;

FIG. 6 illustrates an exemplary first access plane and splined “castled” engagement surface at the spline hinge assembly in accordance with a possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The invention comprises a variety of embodiments, such as a method and apparatus and other embodiments that relate to the basic concepts of the invention.

This invention concerns electrically connecting a stationary housing and a rotating housing of a device through a spline hinge assembly.

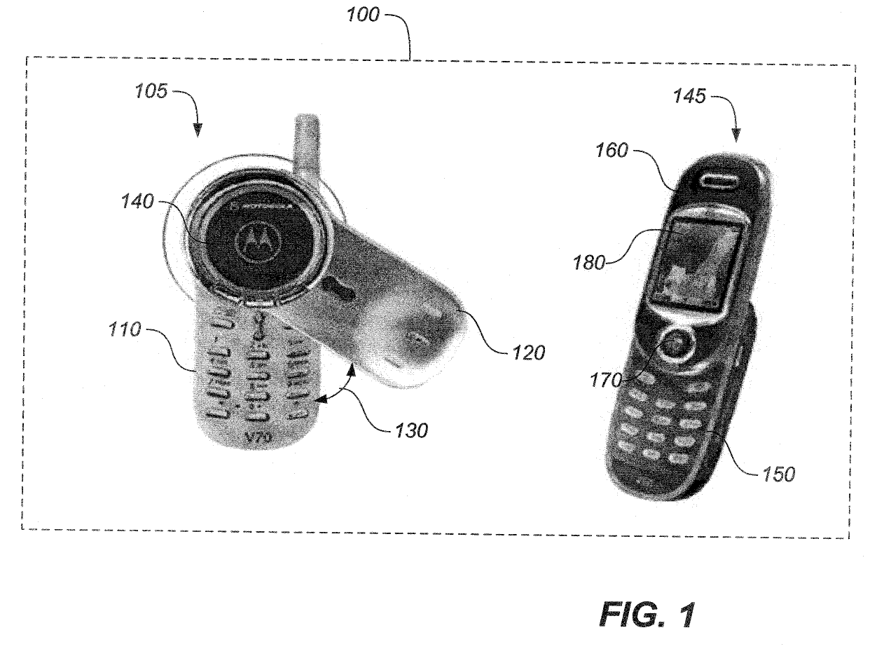

FIG. 1 illustrates an exemplary diagram of electronic devices 100 such as rotator phone 105 and second rotator phone 145 in accordance with a possible embodiment of the invention. The electronic devices 100 may be one or more portable MP3 player, communication device, satellite radio receiver, AM/FM radio receiver, satellite television, portable music player, electronic device, portable computer, wireless radio, wireless telephone, portable digital video recorder, cellular telephone, mobile telephone, personal digital assistant (PDA), or combinations of the above, for example. In particular, a first type of rotator phone 105 includes a stationary housing 110, a rotating housing 120, and a spline hinge assembly 140. Stationary housing 110 and rotating housing 120 represent the stationary and rotating halves of a device such as rotator phone 105. A second type of rotator phone 145 includes a second spline hinge assembly 170, a display 180, a second stationary housing 150, and a second rotating housing 160. The stationary housing 110 or rotating housing 120 could house keyboard, processor, drives, and other devices needed to perform a desired function in rotator phone 105 or second rotator phone 145. The rotating housing 120 can support a display such as display 180 in second rotator phone 145. Data signals and voltage signals for controlling panel display and other hardware can be routed from the stationary housing 110 and the rotating housing 120.

The rotating housing 120 can be rotated about two axes. Specifically, the rotating housing 120 can be rotated such that the angle between the bottom surface of the rotating housing 120 and the corresponding top surface of the stationary housing 110 varies or such that the angle between the longitudinal axis of the rotating housing 120 and that of the stationary housing 110 varies. The stationary housing 110 and rotating housing 120 or the stationary and rotating halves can open both 180 degrees clockwise and counter clockwise for a total of 360 degrees of rotational motion. Preferably, the spline hinge assembly 140 is formed at the central position of one end of the stationary housing 110 and rotating housing 120. Specifically, the rotating housing 120 is rotatably connected to the stationary housing 110 via the spline hinge assembly 140 in a direction in which the rotating housing 120 moves away from the stationary housing 110 via the rotation of the rotating housing 120 about a center of rotation from the position where the rotating housing 120 is substantially placed on the stationary housing 110. The movement between the two housing is measured by arc 130. The rotating housing 120 can be rotated about the hinge in the direction in which the rotating housing 120 moves away from or toward the stationary housing 110. The spline hinge assembly 140 is provided at one end of the stationary housing 110 while being extended vertically.

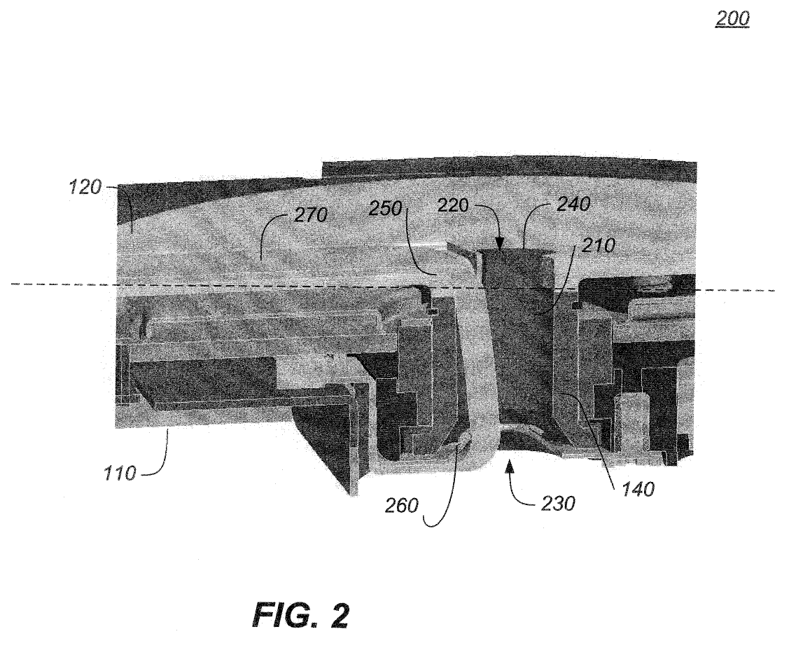

FIG. 2 shows a cross sectional view of mechanism 200 for connecting stationary and rotating halves of a device such as rotator phone 105, in particular the interconnection of the stationary housing 110, rotating housing 120, and spline hinge assembly 140 as shown in FIG. 1. In particular, the mechanism 200 comprises a spline hinge assembly 140 with a first access plane 220 and a second access plane 230, spline or index 240 for aligning and assembling the two halves of the device such as the stationary housing 110 and rotating housing 120, and a cable 270 routed through the spline hinge assembly for exchanging signals and power between the rotating and stationary halves.

The rotating housing 120 is rotatably connected to the stationary housing 110 via the spline hinge assembly 140. The spline hinge assembly 140 has a split construction that allows the rotational half 120 of the device to be a separate sub-assembly from the fixed or stationary half 110. The spline hinge assembly 140 is positioned at the center of rotation and the spline hinge assembly 140 has the ability to transmit torque from the stationary housing 110 or fixed half of the device to the rotating housing 120 or rotating half by use of a spline and gear mechanism. The spline hinge assembly 140 has at least one spline rib 240 that meshes with internal spline grooves on the inner wall of the rotating housing 120. The spline rib and groove allows the rotating housing 120 and the stationary housing 110 to be properly aligned and assembled, and also have the ability to transmit torque through a gear assembly. The barrel section of the spline hinge assembly 140 defines an opening of substantially cylindrical cross-section that is aligned with the rotating housing 120 so as to be collinear. The projecting indexing element (spline rib 240) comprises a short protrusion with a rounded or beveled tip extending from the proximal end of the spline hinge assembly 140.

In addition to providing sub-assembly integration and torque transferring, the spline housing assembly 140 provides an access point or via for a cable to route signals and power from the respective halves of the device. Cable 270 is a micro-coax cable that is ribbonized at the stationary housing 110 and at the rotating housing 120 of the device and bundled in the spline hinge assembly 140. The individual strands of the micro-coax cable have small diameter and lightweight for easy routing with superior mechanical strength and flex life characteristics. In flat ribbon form, cable 270 or the micro-coax cable provides stable electrical properties and excellent electro magnetic interference (EMI) protection without any extra shielding, dramatically reducing the profile of the cable 270. When the cable 270 enters the spline hinge assembly 140 from either the stationary housing 110 or rotating housing 120 it is in a flat ribbon form. The spline hinge assembly 140 may include one or more ramped, radius or chamfered surfaces 250 that taper outward allowing the micro-coax cable or cable 270 to lay flat as it enters and exits the spline hinge assembly 140 without bulging upward and provides strain relief for the individual coax lines. A grommet surface 260 at the second access plane can be used to protect the micro-coax cable 270 from any sharp edges and wear during opening and closing of the device and provides strain relief.

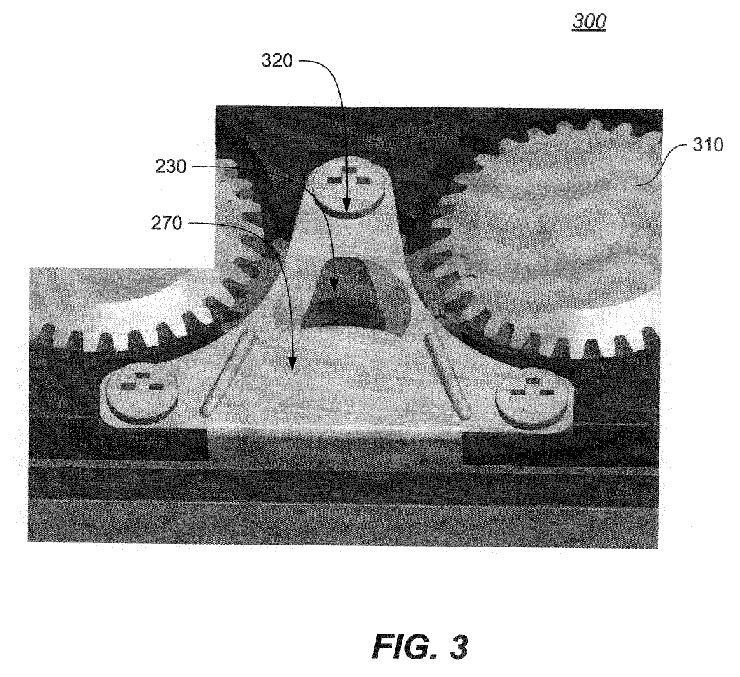

FIG. 3 illustrates gear assembly 300 at stationary housing 110 or at the stationary half of a device in accordance with a possible embodiment of the invention. The second access plane 230 or trough part of spline hinge assembly 140, made of sheet metal or plastic bridge part, separates the micro-coax cable 270 from the relative motion of gear mechanism 310 and provides a routing path for the cable to exchange signals and power with the stationary and rotating halves of the device. Fastener 320 hold the gearing mechanism and second access plane 230 together but can be removed with a cantilevered construction to allow more of the center gear to be viewable. The gear mechanism 310 allows the three gears to be viewed through a transparent window in the device while hiding the interconnection between the rotating and stationary halves.

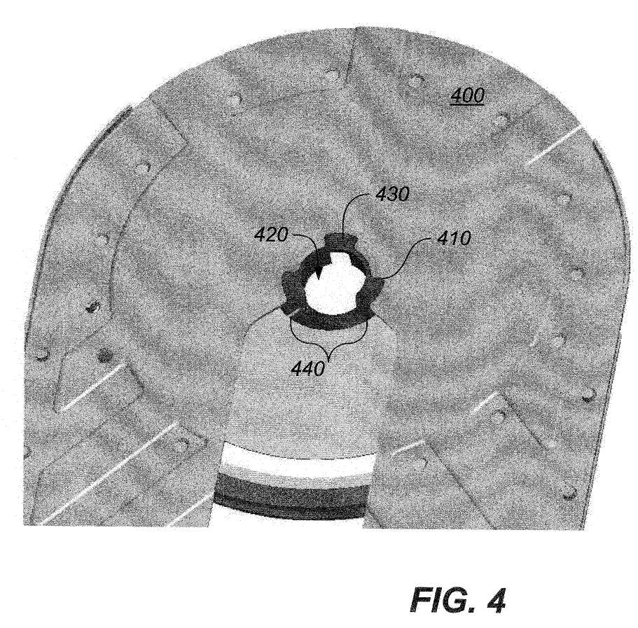

FIG. 4 shows an insert molded plate 400 or sheet metal plate with center index hub (plastic) 430 or index spline molded to the sheet metal plate for coupling the spline hinge assembly 140 with rotational housing 120 or rotational half of a device in accordance with a possible embodiment of the invention. The inserted molded plate 400 with center index hub 430 provide a ready mechanism for assembling different parts of a device and for transferring torque through gear mechanism 310 to rotating housing 120. The inserted molded plate 400 comprises a center index hub 430 and “castled” spline pin 410, access plane 420 or first access plane 220, and chamfered or waterfall surface entry 440 leading into a substantially cylindrical portion of hinge assembly 140. The vertical level or height of each “castled” spline pin 410 and center index hub 430 allows an amount of downward movement that is sufficient to engage or lock the rotation housing 120 to the section of the spline hinge assembly 140. Once coupled, the rotation housing 120 is properly aligned and assembled to the stationary housing 110.

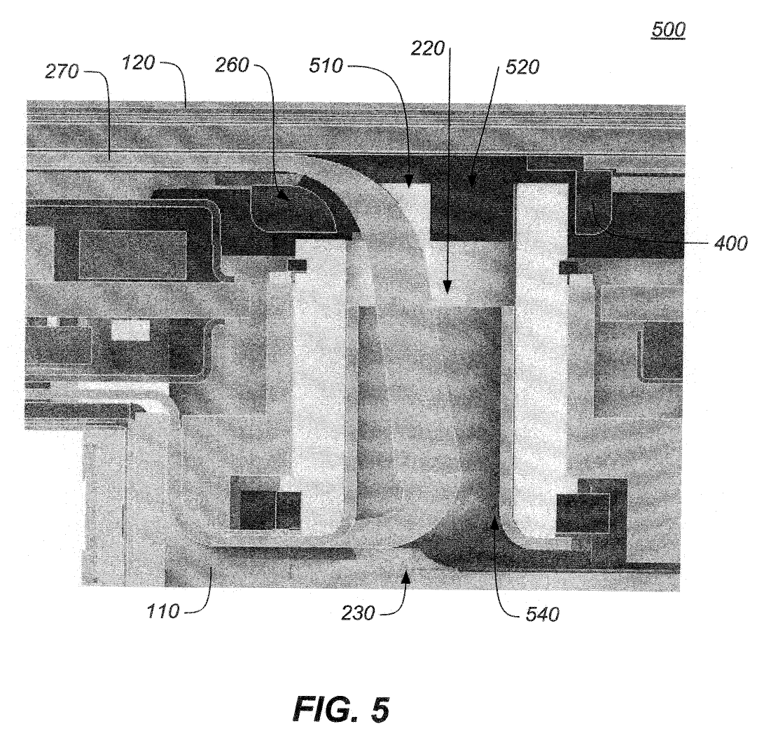

FIG. 5 is an illustration of an assembled apparatus 500 for electrical connection between stationary and rotating halves of a device such as rotator phone 105. In particular, apparatus 500 comprises a rotating housing 120, stationary housing 110, a first access plane 220, a second access plane 230, a first spline rib and spline groove arrangement 510, a second spline rib and spline groove arrangement 520, a cable 270 or micro-coax cable, and a bridge guard 540. The bridge guard 540 comprises a sheet metal bridge or plastic bridge for protecting cable 270 from gear mechanism 310. The bridge guard 540 can be used to separate the micro-coax cable from the motion of the center gear of gearing mechanism 310. The bridge guard 540 allows the top half of the center gear to be visible through a window from the outside of the stationary housing 110. The first spline rib and spline groove arrangement 510, a second spline rib and spline groove arrangement 520 are coupled together to assemble the both halves of a device or the stationary housing 110 and rotating housing 120 of rotator phone 105.

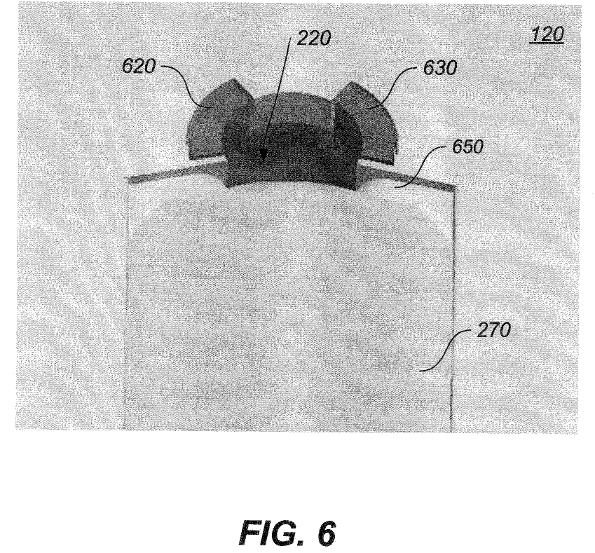

FIG. 6 is a view of the rotational half of a device or rotation housing 120 with index arrangement in accordance to an embodiment. The index arrangement comprises a first index 620 and a second index 630 for combining two separate sub-assemblies such as stationary housing 110 and rotating housing 110. The first index 620 and the second index 630 should be manufactured so as to provide a gap between the spline teeth (indices) and the groove in the housing so as to provide play to take up tolerance build-up in the construction of the housing. The cable 270 or Micro-coax cable enters the center of the rotation from the rotating half of the device. Trough and waterfall radius construction 650 guides and separates the micro-coax cable as it enters the mechanism center of rotation. Although the above description may contain specific details, they should not be construed as limiting the claims in any way.

Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. It does not necessarily need to be one system used by all end users. Accordingly, the appended claims and their legal equivalents should only define the disclosure, rather than any specific examples given.

We claim:

1. A method for electrically connecting a stationary housing and a rotating housing of a device, comprising:
providing a spline hinge assembly pivotally connecting the stationary and rotating housing, wherein the spline hinge assembly has a substantially cylindrical portion having a first and second access plane; and
extending a cable from the stationary housing to the rotating housing through the substantially cylindrical portion of the spline hinge assembly, the cable exiting the substantially cylindrical portion into the stationary housing through the second access plane.

2. The method of claim 1, wherein the spline hinge assembly has at least one index spline to align the stationary housing and the rotating housing.

3. The method of claim 1, wherein the spline hinge assembly defines at least one chamfered surface for guiding the cable into the spline hinge assembly through the first access plane.

4. The method of claim 1, wherein the spline hinge assembly defines a grommet surface at the second access plane.

5. The method of claim 1, wherein the cable is a micro-coax cable.

6. The method of claim 1, wherein the micro-coax cable is ribbonized at the stationary housing and at the rotating housing of the device and bundled in the spline hinge assembly.

7. The method of claim 2, wherein the spline hinge assembly defines at least one chamfered surface for guiding the cable into the spline hinge assembly through the first access plane;
wherein the spline hinge assembly defines a grommet surface at the second access plane;
wherein the cable is micro-coax cable that is ribbonized at the stationary housing and the rotating housing of a device and bundled in the spline hinge assembly.

8. An apparatus for electrical connection between stationary and rotating halves of a device, comprising:
a spline hinge assembly pivotally connecting the stationary and rotating halves, wherein the spline hinge assembly has a substantially cylindrical portion having a first and second access plane; and
a cable electrically connecting the stationary and rotating halves, the cable exiting the substantially cylindrical portion into the stationary half through the second access plane.

9. The apparatus of claim 8, wherein the spline hinge assembly has at least one index spline to align the stationary and rotating halves.

10. The apparatus of claim 8, wherein the spline hinge assembly defines at least one chamfered surface for guiding the cable into the spline hinge assembly through the first access plane.

11. The apparatus of claim 8, wherein the spline hinge assembly defines a grommet surface at the second access plane.

12. The apparatus of claim 8, further comprising:
an external viewing window positioned outside the stationary half of the device and below the second access plane, wherein the second access plane is viewable through the external viewing window.

13. The apparatus of claim 8, wherein the cable is a micro-coax cable.

14. The apparatus of claim 8, wherein the micro-coax cable is ribbonized at the stationary and rotating halves of a device and bundled in the spline hinge assembly.

15. An electronic device, comprising:
a first housing having a first end and a second end;
a second housing rotated such that the angle between one surface of the second housing and a corresponding surface of the first housing varies;
a spline hinge assembly pivotally connecting the first housing and the second housing, wherein the spline hinge assembly has a substantially cylindrical portion having a first and second access plane; and
a cable electrically connecting the second housing to the first housing, the cable exiting the substantially cylindrical portion and into the first housing through the second access plane.

16. The electronic device of claim 15, wherein the spline hinge assembly has at least one index spline to align the first housing with the second housing.

17. The electronic device of claim 16, wherein the spline hinge assembly defines at least one chamfered surface for guiding the cable into the spline hinge through the first access plane.

18. The electronic device of claim 17, wherein the spline hinge assembly defines a grommet surface at the second access plane.

19. The electronic device of claim 15, wherein the cable is a micro-coax cable.

20. The electronic device of claim 19, wherein the micro-coax cable is ribbonized at the first and second housing and bundled in the spline hinge assembly.
